(19) United States
(12) Patent Application Publication
(10) Pub. No.: US 2022/0053100 A1
(43) Pub. Date: Feb. 17, 2022

(54) SYSTEM AND METHOD FOR SOCIAL DISTANCING DURING DEVICE USAGE

(71) Applicant: Toshiba TEC Kabushiki Kaisha, Shinagawa-ku (JP)

(72) Inventor: William SU, Riverside, CA (US)

(21) Appl. No.: 16/992,542

(22) Filed: Aug. 13, 2020

(51) Int. Cl. H04N 1/00; G08B 5/36; G08B 21/18; G06T 7/50; G06K 9/00

(52) U.S. Cl. CPC H04N 1/00323; G08B 5/36; G08B 21/182; H04N 1/00251; G06T 7/50; H04N 2201/0094; H04N 1/00408; H04N 1/00917; H04N 1/00925; G06T 2207/30196; G06K 9/00288

(57) ABSTRACT

A system and method for maintaining safe social distancing during device operation comprises a multifunction peripheral configured to scan or print a tangible document. A camera captures electronic images of two or more people proximate to the multifunction peripheral. A processor determines a relative distance between the people in accordance with captured electronic images and generates an alarm when a determined relative distance is less than a predetermined alarm threshold distance. The processor disables operation of the multifunction peripheral when the determined relative distance is less than the predetermined alarm threshold distance.

### TECHNICAL FIELD

This application relates generally to safe distancing between a device user and other people.

### BACKGROUND

Document processing devices include printers, copiers, scanners and e-mail gateways. More recently, devices employing two or more of these functions are found in office environments. These devices are referred to as multifunction peripherals (MFPs) or multifunction devices (MFDs). As used herein, MFPs are understood to comprise printers, alone or in combination with other of the afore-noted functions. It is further understood that any suitable document processing device can be used.

Work environments, such as in offices, factories or schools, include many workers sharing common spaces. Common spaces may include lunch rooms, meeting rooms or spacing around MFPs. Studies have indicated that humans can be comfortable with someone as close as 2 feet (0.63 meters) away from them.

### BRIEF DESCRIPTION OF THE DRAWINGS

Various embodiments will become better understood with regard to the following description, appended claims and accompanying drawings wherein:

FIG. 1 is an example embodiment of a multifunction peripheral including a social distance warning;

FIG. 2 is an example embodiment of a networked digital device comprised of document rendering system;

FIG. 3 is an example embodiment of proper social distancing;

FIG. 4 is an example embodiment of an alarm notification on a user interface;

FIG. 5 is an example embodiment of a device for determining social distancing; and

FIG. 6 is an example embodiment of a system to promote social distancing safety during multifunction peripheral usage.

### DETAILED DESCRIPTION

The systems and methods disclosed herein are described in detail by way of examples and with reference to the figures. It will be appreciated that modifications to disclosed and described examples, arrangements, configurations, components, elements, apparatuses, devices methods, systems, etc. can suitably be made and may be desired for a specific application. In this disclosure, any identification of specific techniques, arrangements, etc. are either related to a specific example presented or are merely a general description of such a technique, arrangement, etc. Identifications of specific details or examples are not intended to be, and should not be, construed as mandatory or limiting unless specifically designated as such.

While humans can exist comfortably with others in close proximity, such proximity can lead to transmission of airborne diseases through breathing. Individuals can adapt their own behavior to maintain safe distances. Currently, safe “social distancing” guidelines to address the transfer of airborne viruses is around six feet or two meters. In certain situations, a person may be unaware that they are being approached by someone while they are looking elsewhere or performing an activity. A particular example is when a person is using an MFP for copying, scanning, printing, faxing or the like. The user's attention is directed to a device user interface, such as a touchscreen, as well as paper input or output. Another person could easily pass inside of a safe distancing boundary without the user's knowledge.

In late 2019, a novel coronavirus pandemic propagated worldwide. Infection with this coronavirus rapidly spanned the globe. The ensuing disease, referred to as COVID-19, propagated quickly and resulted in a high mortality rate. In COVID-19, “CO” stands for corona, “VI” for virus, and “D” for disease, while the “19” references the year. A novel disease is one where humans have had no prior exposure and therefore have no prior immunity. The COVID-19 contagion is particularly dangerous insofar as onset of symptoms may occur two weeks after a person becomes transmissive. Some carriers of the virus will be asymptomatic or experience minimal symptoms. With such novel and transmissive diseases, face masks and social distancing provide significant benefit to minimizing effects of a pandemic.

The subject application teaches example embodiments wherein an MFP is configured to monitor distances between a device user and others in proximity to the device.

Practicing social distancing helps to reduce opportunities for disease transmission. Additionally, proper distancing can prevent “shoulder surfing,” which is a social engineering technique used to obtain information such as personal identification numbers (PINs), passwords and other confidential data, by looking over another user's shoulder, either from the software keyboard on a MFP device or from sensitive information that is being printed.

In example embodiments, an MFP has a built-in camera and facial recognition software which can determine who should be considered as a current user and who should be considered as others in the area. The MFP determines distance between current user and the others. If the distance is too close, the MFP will give user signals or messages and go into a disabled mode.

The NFP uses any suitable three-dimensional distance formula to determine a distance between the current user and others in real time. An administrator can configure the safe distance and the notification alerts, suitably within set government guidelines or company policy. When an MFP is set to its social distancing mode, social distancing measures are taken to restrict multiple users from coming to the MFP together. The device MFP has a built-in camera and facial recognition software so that it can identify the people at the MFP. The invention can be described as the flowing steps.

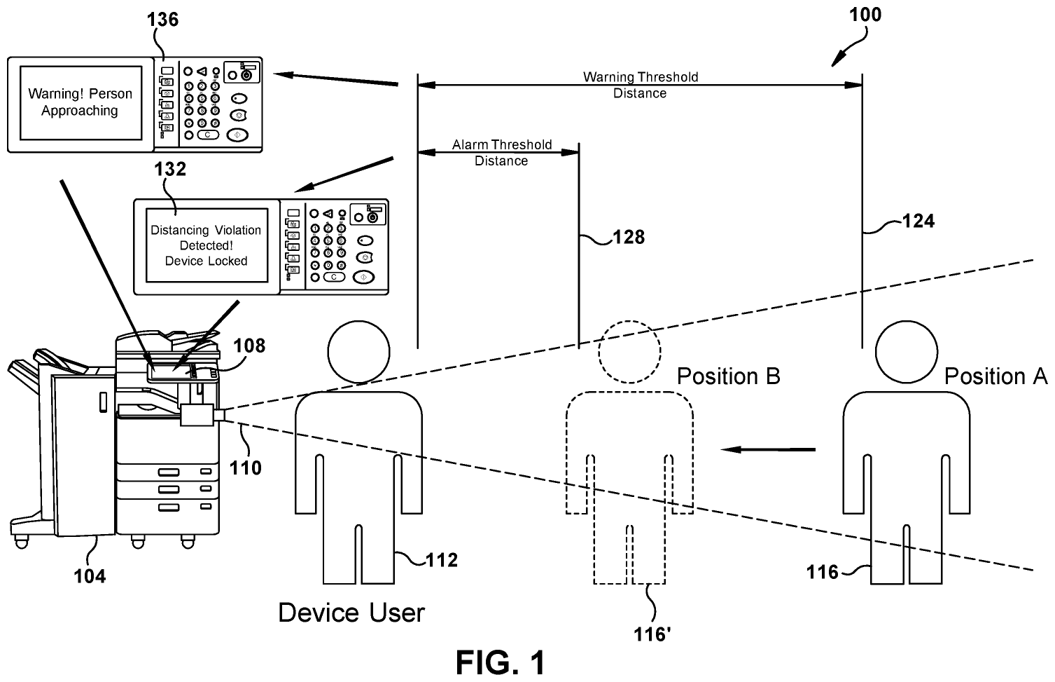

In accordance with the subject application, FIG. 1 illustrates an example embodiment of a system 100 to promote social distancing safety during MFP usage. MFP 104 includes a user interface 108 and a digital camera 110. User interface 108 is suitably comprised of a touchscreen, operable by device user 112 disposed proximate to MFP 104. MFP 104 captures biometric information for user 112, such as a facial image, and applies facial recognition to identify the user 112. A distance of persons, such as user 112, relative to MFP 104 is also suitably determined in accordance with images captured from camera 110. When another person, such as person 116, approaches MFP 104, and thus user 112, they move with a field of vision of camera 110, moving from Position A to Position B. As person 116 approaches, they cross a predefined warning threshold distance 124, suitably defined as a distance greater than a determined minimum safety distance 128. A determined minimum social distance 128 defines an alarm threshold as there becomes significant opportunity for airborne disease transmission. By way of particular example, world health organizations determined that 6 feet or 2 meters is desired minimum distance between individuals to inhibit spread of the COVID-19 coronavirus.

In the example embodiment of FIG. 1, MFP 104 determines that person 116 has crossed warning threshold distance 124 and generates output 136 on user interface 108. Output 136 suitably provides a visual, optical, haptic or audible warning to user 112 that one or more other people are approaching or positioned relatively closely. When person 116 moves to position B, they cross alarm threshold distance 128. MFP 104 then generates output 132 on user interface 108, suitably providing a visual, optical, haptic or audible warning to user 112 that social distancing spacing has been breached so that remedial action can be taken. Such action may include warning person 116 to back away or retreating away directly. When output 136 is generated, MFP 104 disables or suspends device operation, suitably until distancing is re-established or override consent given by user 112 via user interface 108.

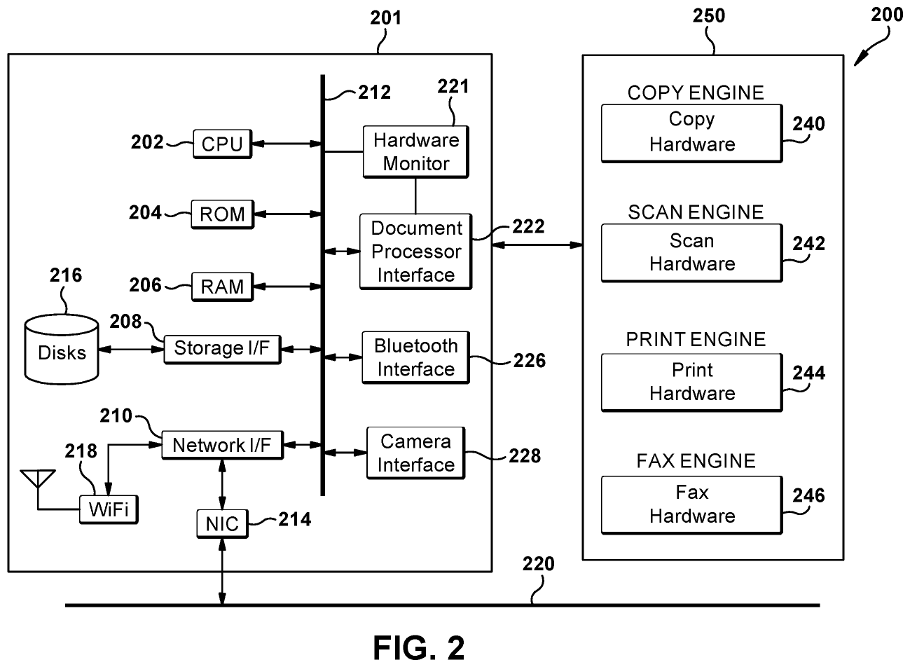

Turning now to FIG. 2 illustrated is an example embodiment of a networked digital device comprised of document rendering system 200 suitably comprised within an MFP, such as with MFP 104 of FIG. 1. It will be appreciated that an MFP includes an intelligent controller 201 which is itself a computer system. Included in controller 201 are one or more processors, such as that illustrated by processor 202. Each processor is suitably associated with non-volatile memory, such as read only memory (ROM) 204, and random access memory (RAM) 206, via a data bus 212.

Processor 202 is also in data communication with a storage interface 208 for reading or writing data with storage 216, suitably comprised of a hard disk, optical disk, solid-state disk, cloud-based storage, or any other suitable data storage as will be appreciated by one of ordinary skill in the art.

Processor 202 is also in data communication with a network interface 210 which provides an interface to a network interface controller (NIC) 214, which in turn provides a data path to any suitable wired or physical network connection 220, or to a wireless data connection via a wireless network interface, such as WiFi 218. Example wireless connections include cellular, Wi-Fi, wireless universal serial bus (wireless USB), satellite, and the like. Example wired interfaces include Ethernet, USB, IEEE 1394 (FireWire), Lightning, telephone line, or the like. Processor 202 is also in data communication with a hardware monitor 221, suitably amassing state data from subassemblies, sensors, digital thermometers, or the like, and suitably including digital state date including device codes, such as device error codes. Processor 202 can also be in data communication a document processor interface 222, with BLUETOOTH interface 226 and camera interface 228 via data path 212.

Processor 202 can also be in data communication with any suitable user input/output (I/O) interface (not shown) which provides data communication with user peripherals, such as displays, keyboards, mice, track balls, touch screens, or the like.

Document processor interface 222 is suitable for data communication with MFP functional units 250. In the illustrated example, these units include a copy engine, suitably comprised of copy hardware 240, a scan engine, suitably comprised of scan hardware 242, a print engine, suitably comprised of print hardware 244 and a fax engine, suitably comprised of fax hardware 246. These subsystems together comprise MFP functional hardware 250. It will be understood that functional units are suitably comprised of intelligent units, including any suitable hardware or software platform.

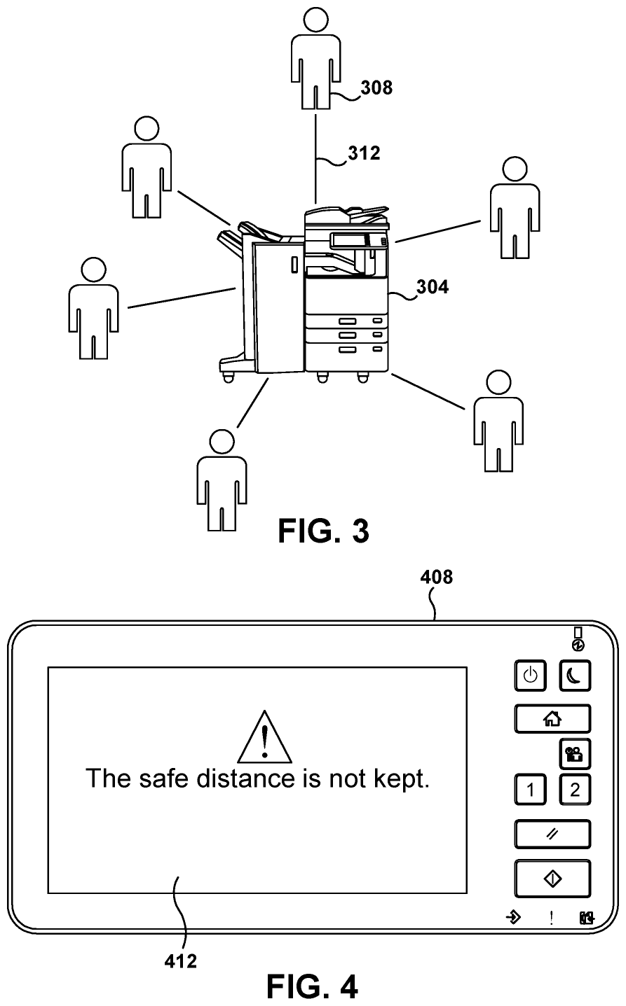

FIG. 3 illustrates proper social distancing at an MFP 304 wherein each of a plurality of persons, such as person 308, maintain safe social distance by a specified distance 312.

FIG. 4 illustrates an example embodiment of an alarm notification on user interface 408 comprising touchscreen 412. The illustrated notification suitably corresponds with disabling or suspending MFP operation. Such notification may also comprise a warning which does not include MFP disabling as detailed above.

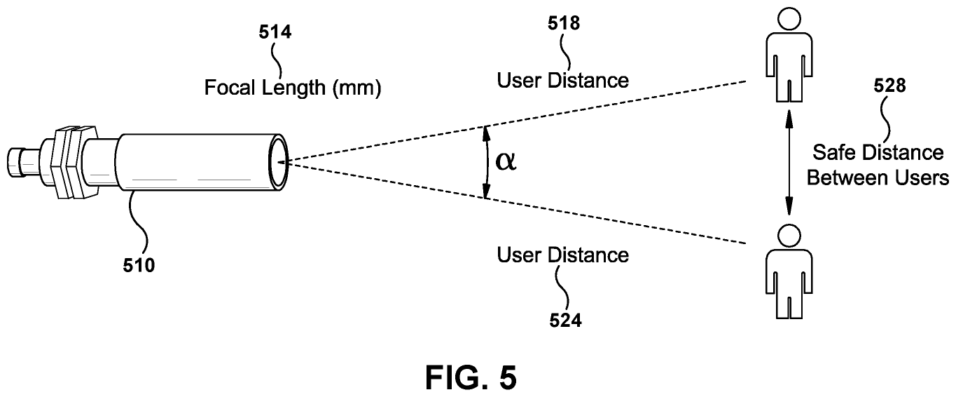

FIG. 5 illustrates an example embodiment of a device for determining distancing, such as with camera 110 of FIG. 1. In the illustrated example, digital camera 510 provides computational input including a focal length 514 and image capture angle a to determine user distance 518, 524 and safe distance 528, suitably determined with an assumed height for an average individual.

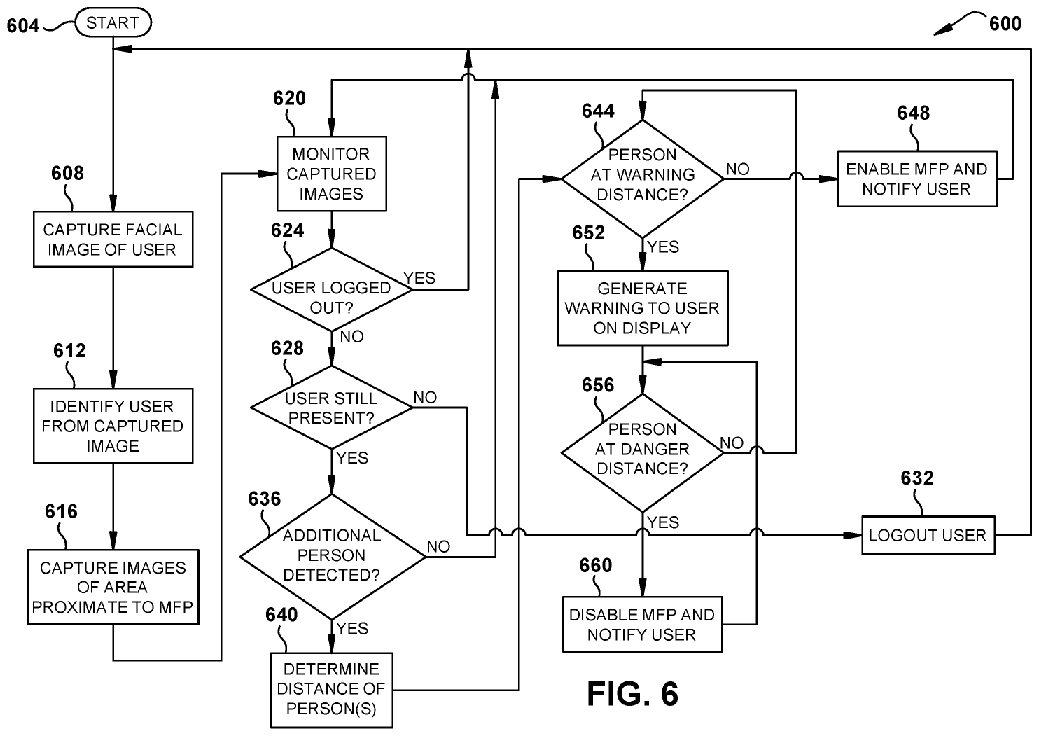

FIG. 6 is a flowchart 600 of an example embodiment of a system to promote social distancing safety during MFP usage. The process commences at block 604 and proceeds to block 608 where a facial image of a device user is captured. The user is identified at block 612, and such identification is suitably used to define the user as the one against whom social distancing is to be determined as well as to log the user in for MFP use. Images of areas around the MFP are captured at block 616 and monitored at block 620. If a user is determined to be logged out at block 624, the system suitably returns to block 608. If the user is still logged in, a determination is made at block 628 if the user is still present, such as within camera field of view. If not, the system logs the user out at block 632 and returns to block 608. If the user is still present, a determination is made at block 636 as to whether one or more other persons have been detected. If not, the system returns to block 620. If so, distancing is determined at block 640, and if any person is determined to be at a warning distance at block 644. If not, the MFP is enabled and the user so notified at block 648 before the system returns to block 620. If so, a warning is generated on the MFP user interface at block 652.

Next, a determination is made at block 656 as to whether any person has exceeded a danger threshold. If not, the process returns to block 644. If so, the MFP is disabled and user notified at block 660, and a loop is made back to block 656 to keep the warning displayed and MFP disabled until such time proper distancing is achieved. Once this occurs the process proceeds back to block 644.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the spirit and scope of the inventions.

What is claimed is:

1. A multifunction peripheral comprising:
a document processing engine configured to scan or print a tangible document;
a camera configured to capture one or more electronic images of two people proximate to the multifunction peripheral;
memory; and
a processor,
the processor configured to determine a relative distance between the people in accordance with the captured electronic images,
the processor further configured to generate an alarm when a determined relative distance is less than a predetermined alarm threshold distance, and
the processor further configured to disable operation of the multifunction peripheral when the determined relative distance is less than the predetermined alarm threshold distance.

2. The multifunction peripheral of claim 1 wherein the processor is further configured to issue a warning when the determined relative distance is less than a predetermined warning threshold distance.

3. The multifunction peripheral of claim 2 wherein:
the camera is further configured to capture an electronic image of a third person proximate to the multifunction peripheral,
the processor is further configured to identify one of the people as a device user in accordance with a captured electronic image, and
the processor is further configure to generate the alarm in accordance with a determined relative distance between the user and another person.

4. The multifunction peripheral of claim 3 wherein:
the processor is further configured to receive identification data indicative of an identity of the user; and
the processor is further configured to identify the user in accordance with a correspondence between received identification data and an identity of the user determined from facial recognition from the captured electronic image.

5. The multifunction peripheral of claim 1 wherein the alarm threshold distance is set in accordance with governmental distancing guidelines for communicable diseases.

6. The multifunction peripheral of claim 1 wherein the alarm threshold distance is set in accordance with a viewing distance of a user interface of the multifunction peripheral.

7. The multifunction peripheral of claim 1 wherein the processor is further configured to generate the alarm as indicia on a display of the multifunction peripheral.

8. The multifunction peripheral of claim 1 wherein the processor is further configured to re-enable the multifunction peripheral when the determined relative distance becomes greater than the predetermined alarm threshold distance.

9. A method comprising:
scanning or printing a tangible document;
capturing one or more electronic images of two people proximate to a multifunction peripheral;
determining a relative distance between the people in accordance with captured electronic images;
generating an alarm when a determined relative distance is less than a predetermined alarm threshold distance; and
disabling operation of the multifunction peripheral when the determined relative distance is less than the predetermined alarm threshold distance.

10. The method of claim 9 further comprising issuing a warning when the determined relative distance is less than a predetermined warning threshold distance.

11. The method of claim 10 further comprising:
capturing an electronic image of a third person proximate to the multifunction peripheral;
identifying one of the people as a device user in accordance with a captured electronic image; and
generating the alarm in accordance with a determined relative distance between the user and another person.

12. The method of claim 11 further comprising:
receiving identification data indicative of an identity of the user;
identifying the device user in accordance with a correspondence between received identification data and an identity of the user determined from facial recognition from the captured electronic image.

13. The method of claim 9 further comprising setting the alarm threshold distance in accordance with governmental distancing guidelines for communicable diseases.

14. The method of claim 9 further comprising setting the alarm threshold distance in accordance with a viewing distance of a user interface of the multifunction peripheral.

15. The method of claim 9 further comprising generating the alarm as indicia on a display of the multifunction peripheral.

16. The method of claim 9 further comprising re-enabling the multifunction peripheral when the determined relative distance becomes greater than the predetermined alarm threshold distance.

17. A system comprising:
a memory storing threshold data indicative of a preselected social distancing threshold;
a camera configured to capture digital images comprising a plurality of persons; and
a processor,
the processor configured to identify one of the plurality of persons as a user of a device in accordance with facial recognition performed on a captured digital image,
the processor further configured to, in real time, determine relative distances between the user and one or more other persons of the plurality,
the processor further configured to generate a prompt to the user when any relative distance between the user and any other person exceeds the preselected social distancing threshold, and
the processor further configured to disable use of the system until such time as no other person exceeds the preselected social distancing threshold.

18. The system of claim 17 wherein the processor is further configured to remove the prompt when no other person exceeds the preselected social distancing threshold.

19. The system of claim 17 wherein the processor determines relative distance in accordance with a preselected three-dimensional distancing formula.

20. The system of claim 17 wherein the preselected social distancing threshold is set in accordance with governmental distancing guidelines for communicable diseases.
